(19) United States
(12) Patent Application Publication
(10) Pub. No.: US 2023/0343349 A1
(43) Pub. Date: Oct. 26, 2023

(54) DIGITAL AUDIO EMOTIONAL RESPONSE FILTER

(71) Applicant: Sony Interactive Entertainment Inc., Tokyo (JP)

(72) Inventors: Glenn Black, San Mateo, CA (US); Celeste Bean, San Mateo, CA (US); Michael Taylor, San Mateo, CA (US)

(21) Appl. No.: 17/725,007

(22) Filed: Apr. 20, 2022

(51) Int. Cl. G10L 21/007; G10L 25/63

(52) U.S. Cl. CPC G10L 21/007; G10L 25/63

(57) ABSTRACT

A prime user is given the ability to apply selective digital signal processing to incoming voice chat audio to prevent being exposed to excessively emotional communication. The incoming audio level can be normalized as a user starts yelling, or tonality can be removed when angry/aggressive tones are being used to produce a robotic or toneless voice.

### FIELD

The present application relates generally to digital audio emotional response filters

### BACKGROUND

As recognized herein, in social network situations a prime user may wish to not be exposed to excessive emotion in the voice playback of another user in the network, or may not wish to be exposed to specific types of emotions, but nonetheless discover the content of what an emotional user is saying.

### SUMMARY

An apparatus includes at least one computer storage that is not a transitory signal and that in turn includes instructions executable by at least one processor to receive incoming signals from a computerized communication session. The signals represent a voice of at least a first participant in the computerized communication session. The instructions are executable to, based at least in part on the signals, determine at least a first emotion, and alter playback of the voice to reduce the first emotion present in playback.

In some embodiments the instructions can be executable to, based at least in part on the signals, determine at least a second emotion, and not alter playback of the voice to reduce the second emotion present in playback. In such examples the instructions can be executable to receive input designating the first emotion as an emotion to alter in playback and the second emotion as an emotion to not alter in playback. This means that a user can extract a particular emotion from one participant's voice but may not wish to extract another emotion from the participant's voice.

In example implementations the instructions may be executable to receive incoming signals from the computerized communication session. The signals represent a voice of at least a second participant in the computerized communication session. The instructions can be executable to, based at least in part on the signals, determine at least the first emotion, and not alter playback of the voice of the second participant having the first emotion in playback of the voice of the second participant. This means that a user can extract a particular emotion from one participant's voice but may not wish to extract the same emotion from another participant's voice. Accordingly, the instructions can be executable to receive input designating the first participant whose emotion should be altered and the second participant whose emotion should not be altered.

In non-limiting examples the instructions can be executable to alter playback of the voice to reduce the first emotion present in playback at least in part by playing the voice of the first participant after filtering the voice through a signal processing circuit.

In other non-limiting examples, the instructions can be executable to alter playback of the voice to reduce the first emotion present in playback at least in part by playing speech uttered by the first participant in a robotic voice.

In another aspect, a method includes receiving a user-designated first emotion as an emotion to be reduced in playback, and altering a voice signal in a computerized communication system to reduce the first emotion in the voice signal when the voice signal is played back.

In another aspect, an apparatus includes at least one microphone, at least one transceiver, and at least one processor programmed with instructions to receive input designating a first emotion to be reduced in outgoing speech received from the microphone prior to transmitting the speech through the transceiver. The instructions are executable to, responsive to detecting the first emotion in outgoing speech, alter the speech to reduce the first emotion therein to render altered speech, and to transmit the altered speech through the transceiver.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates example logic in example flow chart format consistent with present principles for alleviating excessive emotion in incoming voice chat;

FIG. 3 illustrates example logic in example flow chart format consistent with present principles for alleviating excessive emotion in outgoing voice chat;

FIG. 4 illustrates an example screen shot for incoming voice chat emotion filtering selection;

FIG. 5 illustrates an example screen shot for outgoing voice chat emotion filtering selection;

FIGS. 6 and 7 illustrate example screen shots for additional details of emotion filtering; and

FIGS. 8 and 9 illustrate example logic in example flow chart format for employing one or more machine learning (ML) models consistent with present principles.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

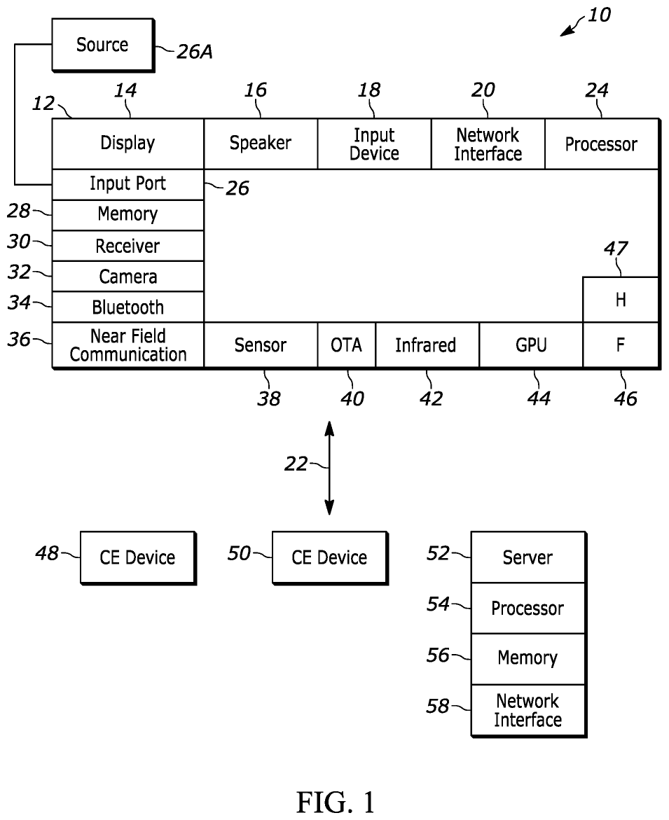

Referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage mediums 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of motion sensors such as accelerometers, gyroscopes, and magnetometers to determine the location and orientation of the AVD 12 in three dimension or by an event-based sensor such as an event detection sensor (EDS) outputting binary indications of change in direction of a parameter.

Continuing the description of the AVD 12, in some embodiments the AVD 12 may include one or more cameras 32 that may be a thermal imaging camera, a digital camera such as a webcam, an event-based sensor, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 (e.g., a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command)) that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content.

In the example shown, only two CE devices are shown, it being understood that fewer or greater devices may be used. A device herein may implement some or all of the components shown for the AVD 12 and/or CE devices. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

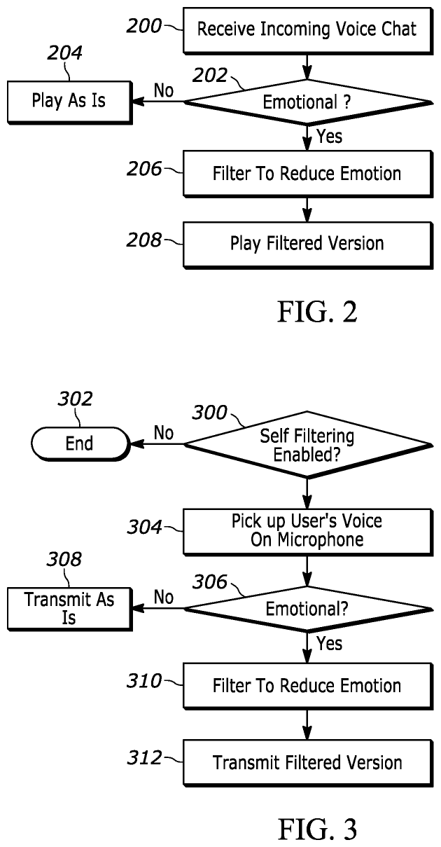

Refer now to FIG. 2. Commencing at block 200, incoming voice signals from, for example, a voice chat computerized communication session, may be received at a user terminal such as may be instantiated by any device described herein. Proceeding to decision diamond 202, it is determined whether the voice signals betray an emotion satisfying a threshold, and if not, the voice is played on speakers as is at block 204.

On the other hand, if the emotion in the voice is evaluated as satisfying the threshold, the logic flows from decision diamond 202 to block 206 to filter or otherwise alter the voice signal to reduce if not completely eliminate the emotion, playing the altered version at block 208.

While FIG. 2 is directed to detecting emotion in an incoming voice, FIG. 3 is directed to allowing a user to cause his voice to be processed to prevent excessive emotion in outgoing chat. Commencing at decision diamond 300, it is determined whether the user has enabled self-filtering, and if not, the process ends at state 302.

When self-filtering is enabled, the logic moves to block 304 to pick up the user's voice on a microphone, e.g., the computer microphone of a computer terminal such as any device herein used for voice chat. Proceeding to decision diamond 306, it is determined whether the voice signals betray an emotion satisfying a threshold, and if not, the voice is transmitted from a communication interface such as any interface described herein as is to recipient devices at block 308.

On the other hand, if the emotion in the voice is evaluated as satisfying the threshold, the logic flows from decision diamond 306 to block 310 to filter or otherwise alter the voice signal to reduce if not completely eliminate the emotion, transmitting the altered version at block 312.

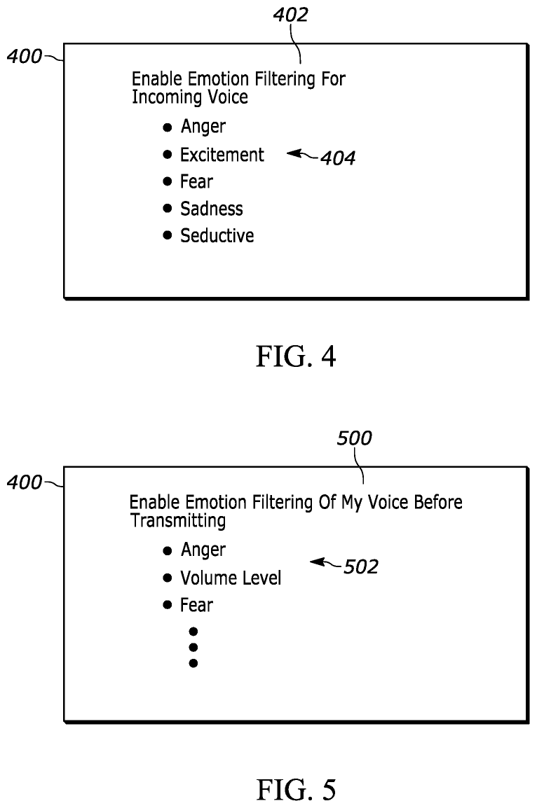

FIG. 4 illustrates a UI that may be presented on a display 400 such as any display herein for allowing a user to identify specific types of emotions to be filtered from voice in the incoming case of FIG. 2. A prompt 402 may be selected to enable voice filtering of incoming voices to reduce if not eliminate specific types of emotions. A list 404 of emotions may be presented from which the user may select one or more emotions to filter.

FIG. 5 illustrates a UI that may be presented on a display 400 such as any display herein for allowing a user to identify specific types of emotions to be filtered from voice in the outgoing case of FIG. 3. A prompt 500 may be selected to enable voice filtering of the user's outgoing voice to reduce if not eliminate specific types of emotions. A list 502 of emotions may be presented from which the user may select one or more emotions to filter. As shown, the list 502 may include emotions per se as well as voice attributes such as “loudness”, which is selected will cause outgoing voice signals to be modulated in volume to remain below a threshold volume.

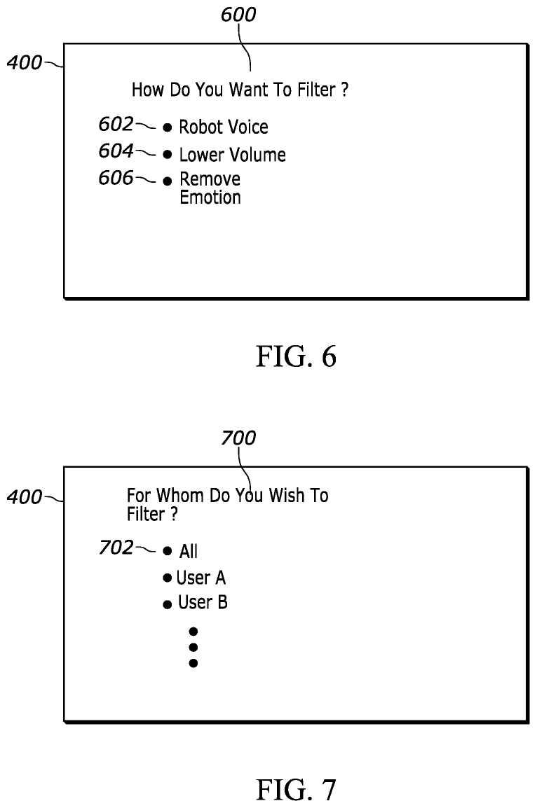

FIG. 6 illustrates a UI that may be presented on a display 400 such as any display herein for allowing a user to identify how a voice should be filtered to reduce emotion. A prompt 600 may be presented for the user to select the filtering technique. In the example shown, the user can select at 602 to have a voice triggering the emotion threshold to be played in a robot voice, which is typically toneless. The user can also select at 604 to simply reduce the volume at which an emotional voice is played. The user may also select at 606 to play the voice in its received timbre but with the voice flattened or otherwise played with reduced emotion. Generative adversarial networks (GAN) are an example technique for such voice filtering.

Note that responsive to an emotion triggering a threshold, the system may default to executing speech-to-text on the emotional voice and reproduce the text in a robotic voice.

FIG. 7 illustrates a UI that may be presented on a display 400 such as any display herein for allowing a user to identify specific users to filter should their voices contain emotion satisfying a threshold. The UI includes a prompt 700 for the user to identify other users to filter, followed by a list 702 of individual users plus an “all” selector to filter all user voices for emotions.

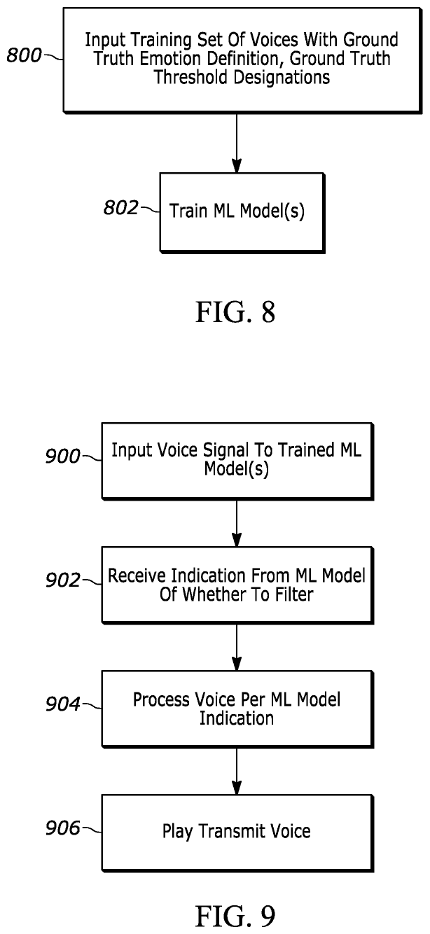

FIG. 8 illustrates techniques for training one or more machine learning (ML) models such as one or more CNNs to detect specific emotions in voices and when those emotions satisfy a threshold for employing the filtering/altering techniques described herein. Commencing at block 800, a training set of recorded human voices is input to one or more ML models. Along with the voice recordings, ground truth is annotated to the voices and input to the ML model(s) to train the model(s). The ground truth may include a specific emotion annotated for each voice as well as an indication as to whether that particular voice with its annotated ground truth emotion is to be regarded as satisfying a filtering threshold. The ML model(s) is/are trained at block 802 on the training set input at block 800.

FIG. 9 indicates that subsequently, at block 900 a voice signal (incoming or outgoing as the case may be) is input to the trained ML model(s). Proceeding to block 902, an indication is received back from the output of the ML model(s) indicating whether the voice should be altered consistent with disclosure herein. The voice is processed according to the indication at block 904, i.e., if the indication is to the effect that the voice contains an emotion satisfying a threshold, the voice is altered. The voice is played (or transmitted, as the case may be) at block 906.

While the UIs herein are shown to enable a user to define specific emotions, users, and filtering techniques, it is to be understood that all incoming voices for example may be automatically filtered for predetermined emotions using predetermined techniques, relieving the user of making choices.

While the particular embodiments are herein shown and described in detail, it is to be understood that the subject matter which is encompassed by the present invention is limited only by the claims.

1. An apparatus, comprising:
at least one computer storage that is not a transitory signal and that comprises instructions executable by at least one processor to:
receive incoming signals from a computerized communication session, the signals representing a voice of at least a first participant in the computerized communication session;
based at least in part on the signals, determine at least a first emotion; and
alter playback of the voice on at least one playback apparatus to reduce the first emotion present in playback on the at least one playback apparatus.

2. The apparatus of claim 1, wherein the instructions are executable to:
based at least in part on the signals, determine at least a second emotion; and
not alter playback of the voice to reduce the second emotion present in playback.

3. The apparatus of claim 2, wherein the instructions are executable to:
receive input designating the first emotion as an emotion to alter in playback and the second emotion as an emotion to not alter in playback.

4. The apparatus of claim 1, wherein the instructions are executable to:
receive incoming signals from the computerized communication session, the signals representing a voice of at least a second participant in the computerized communication session;
based at least in part on the signals, determine at least the first emotion; and
not alter playback of the voice of the second participant having the first emotion in playback of the voice of the second participant.

5. The apparatus of claim 4, wherein the instructions are executable to:
receive input designating the first participant whose emotion should be altered and the second participant whose emotion should not be altered.

6. The apparatus of claim 4, wherein the instructions are executable to:
alter playback of the voice to reduce the first emotion present in playback at least in part by playing the voice of the first participant after filtering the voice through a signal processing circuit.

7. The apparatus of claim 4, wherein the instructions are executable to:
alter playback of the voice to reduce the first emotion present in playback at least in part by playing speech uttered by the first participant in a robotic voice.

8. The device of claim 1, comprising the at least one processor programmed with the instructions.

9. A method, comprising:
receiving a user-designated first emotion as an emotion to be reduced in playback; and
altering a voice signal in a computerized communication system to reduce the first emotion in the voice signal when the voice signal is played back.

10. The method of claim 9, wherein the voice signal is received by a receiver and the method comprises:
altering the voice signal to reduce the first emotion after being received and prior to playback.

11. The method of claim 9, comprising altering the voice signal to reduce the first emotion prior to transmitting the voice signal.

12. The method of claim 9, comprising:
determining at least a second emotion; and
not altering playback of the voice to reduce the second emotion present in playback.

13. The method of claim 12, wherein the instructions are executable to:
receiving input designating the first emotion as an emotion to alter in playback and the second emotion as an emotion to not alter in playback.

14. The method of claim 9, comprising:
receiving incoming signals from the computerized communication session, the signals representing a voice of at least a second participant in the computerized communication session;
based at least in part on the signals, determining at least the first emotion; and
not altering playback of the voice of the second participant having the first emotion in playback of the voice of the second participant.

15. The method of claim 14, comprising:
receiving input designating the first participant whose emotion should be altered and the second participant whose emotion should not be altered.

16. The method of claim 9, comprising:
altering the voice signal at least in part by filtering the voice signal through a signal processing circuit.

17. The method of claim 9, comprising:
altering the voice signal at least in part by playing speech in a robotic voice.

18. An apparatus, comprising:
at least one microphone;
at least one transceiver; and
at least one processor programmed with instructions to:
receive input designating a first emotion to be reduced in outgoing speech received from the microphone prior to transmitting the speech through the transceiver;
responsive to detecting the first emotion in outgoing speech, alter the speech to reduce the first emotion therein to render altered speech; and
transmit the altered speech through the transceiver.

19. The apparatus of claim 18, wherein the instructions are executable to:
responsive to detecting a second emotion in outgoing speech, not alter the speech to reduce the second emotion therein prior to transmitting the speech.

20. The apparatus of claim 18, wherein the instructions are executable to:
alter the outgoing speech by transmitting a robotic version of the outgoing speech.
